(19) United States
(12) Patent Application Publication
(10) Pub. No.: US 2014/0054487 A1
(43) Pub. Date: Feb. 27, 2014

(54) VALVE OPERATOR ASSEMBLY WITH ANTI-BACKDRIVING DEVICE

(71) Applicants: Ali A. Namous, Allentown, PA (US); Charles Stahl, Clay, MI (US)

(72) Inventors: Ali A. Namous, Allentown, PA (US); Charles Stahl, Clay, MI (US)

(73) Assignee: Aktiebolaget SKF, Goteborg (SE)

(21) Appl. No.: 13/996,237

(22) PCT Filed: Dec. 20, 2011
(86) PCT No.: PCT/US11/65976

§ 371 Date: Nov. 11, 2013

Related U.S. Application Data
(60) Provisional application No. 61/425,142, filed on Dec. 20, 2010.

(51) Int. Cl. F16K 3/00

(52) U.S. Cl. CPC F16K 3/00
USPC 251/326

(57) ABSTRACT

A high efficiency operator assembly is for a valve for controlling flow through a passage, the valve including a closure element movable between a closed position at which the member substantially obstructs the passage and an open position. The operator assembly includes a movable stem having opposing ends, a first end being connectable with the closure element such that displacement of the stem moves the closure element between the open and closed positions. A stem driver is rotatable about a central axis, engaged with the stem, and configured to displace the stem when the driver angularly displaces about the axis and an input device is rotatable about the axis. A lock mechanism or a clutch is engageable with the stem, the stem driver, or the input device to retain the closure element at a particular position when the input device remains at a particular angular position about the input axis.

The present invention relates to valves, and more particularly to high efficiency valve operator assemblies.

High efficiency valve operator assemblies are known and basically include a low torque mechanism for actuating a valve closure element, such as for example, a roller screw assembly attached to the closure element. Such operator assemblies are termed high efficiency due to the fact that the associated actuator mechanism is constructed having substantially reduced friction, such that less torque is required to rotate the actuator and thereby operate the valve. One problem with high efficiency operators for gate valves used in high pressure applications is the tendency for fluid pressure to “back drive” the actuator such that the valve is inadvertently opened or closed. Such back driving can not only cause problems with the desired flow regulation, but can also lead to injury to an operator, for example, from being struck by a rotating handle.

A known solution for preventing back driving of a valve is to provide a second or “balance” stem attached to the gate valve and which is exposed to fluid pressure to offset or balance the force exerted on the closure element. However, the additional balance stem must be sealed, introducing additional potential leakage paths, and in certain stem-balanced valve constructions, the passage for the balance stem is open to the exterior environment, making such valves inappropriate to use in subsea applications.

### SUMMARY OF THE INVENTION

In one aspect, the present invention is a high efficiency operator assembly for a valve for controlling flow through a passage, the valve including a closure element movable between a closed position at which the member substantially obstructs the passage and an open position. The operator assembly comprises a movable stem having opposing first and second ends, the first end being connectable with the closure element such that displacement of the stem moves the closure element between the open and closed positions. A stem driver is rotatable about a central axis, engaged with the stem, and configured to displace the stem when the driver angularly displaces about the central axis. An input device is rotatable about a central axis and a lock mechanism is operatively engageable with the stem, the stem driver, or the input device so as retain the closure element at about particular position when the input device remains generally at a particular angular position about the input axis.

In another aspect, the present invention is again a high efficiency valve assembly for controlling flow through a passage generally as described above, but with the lock mechanism replaced by a clutch. The clutch, which may be a formsprag clutch, is configured to operatively couple the input device with the stem driver such that rotation of the input device rotates the stem driver about the driver axis and configured to substantially prevent angular displacement of the stem driver from torque applied by the stem.

### BRIEF DESCRIPTION OF THE SEVERAL VIEWS OF THE DRAWINGS

The foregoing summary, as well as the detailed description of the preferred embodiments of the present invention, will be better understood when read in conjunction with the appended drawings. For the purpose of illustrating the invention, there is shown in the drawings, which are diagrammatic, embodiments that are presently preferred. It should be understood, however, that the present invention is not limited to the precise arrangements and instrumentalities shown. In the drawings:

FIG. 1 is an axial cross-sectional view through the valve operator of the present invention;

FIG. 2 is a perspective view of the operator cross-section shown in FIG. 1;

FIG. 3 is another axial cross-sectional view of the actuator, shown mounted on a valve assembly;

FIGS. 4A and 4B, collectively FIG. 4, are each a reduced view of FIG. 3 showing the valve closure element in an open position (FIG. 4A) and in a closed position (FIG. 4B);

FIG. 5 is an exploded perspective view of the valve operator assembly;

FIG. 6 is an exploded, axial cross-sectional view of the valve operator assembly;

FIG. 7 is an enlarged view of a portion of FIG. 1, showing a stem driver and a portion of a stem;

FIG. 8 is a more detailed view of the valve operator portion shown in FIG. 7, showing the details of a preferred ball screw actuator;

FIG. 9 is another view of the operator portion of FIG. 7, showing the details of an alternative, roller screw actuator;

FIG. 10 is an axial cross-sectional view of a preferred lock mechanism formed as a first construction clutch;

FIG. 11 is a broken-away, enlarged view of an upper portion of FIG. 10;

FIGS. 12A and 12B, collectively FIG. 12, are each an enlarged view of a portion of FIG. 11, FIG. 12A showing an output member engaged with a clutch member and FIG. 12B showing the output member disengaged from the clutch member;

FIGS. 13A-13D, collectively FIG. 13, are each a broken-away, axial cross-sectional view through line 13-13 of FIG. 11, each showing a different point in the process of driving the output member with an input member;

FIG. 14 is an exploded view of a second construction of a lock mechanism including a clutch;

FIG. 15 is a radial cross-sectional view through an input member, brake members and pins of the second construction clutch;

FIG. 16 is a radial cross-sectional view through the brake members and an output member of the clutch, showing the clutch configuration when the output member has displaced relative to the input member;

FIG. 17 is an enlarged view of a portion of FIG. 15, showing the pivoting movement caused by the displacement of the pin when the output member has displaced relative to the input member; and

FIG. 18 is a more diagrammatic, cross-sectional view of a third construction of the lock mechanism including a hydraulic assembly.

### DETAILED DESCRIPTION OF THE INVENTION

Certain terminology is used in the following description for convenience only and is not limiting. The words “inner”, “inwardly” and “outer”, “outwardly” refer to directions toward and away from, respectively, a designated axis, a centerline or a geometric center of an element being described, the particular meaning being readily apparent from the context of the description. Further, as used herein, the word “connected” is intended to include direct connections between two members without any other members interposed therebetween and indirect connections between members in which one or more other members are interposed therebetween. The terminology includes the words specifically mentioned above, derivatives thereof, and words of similar import.

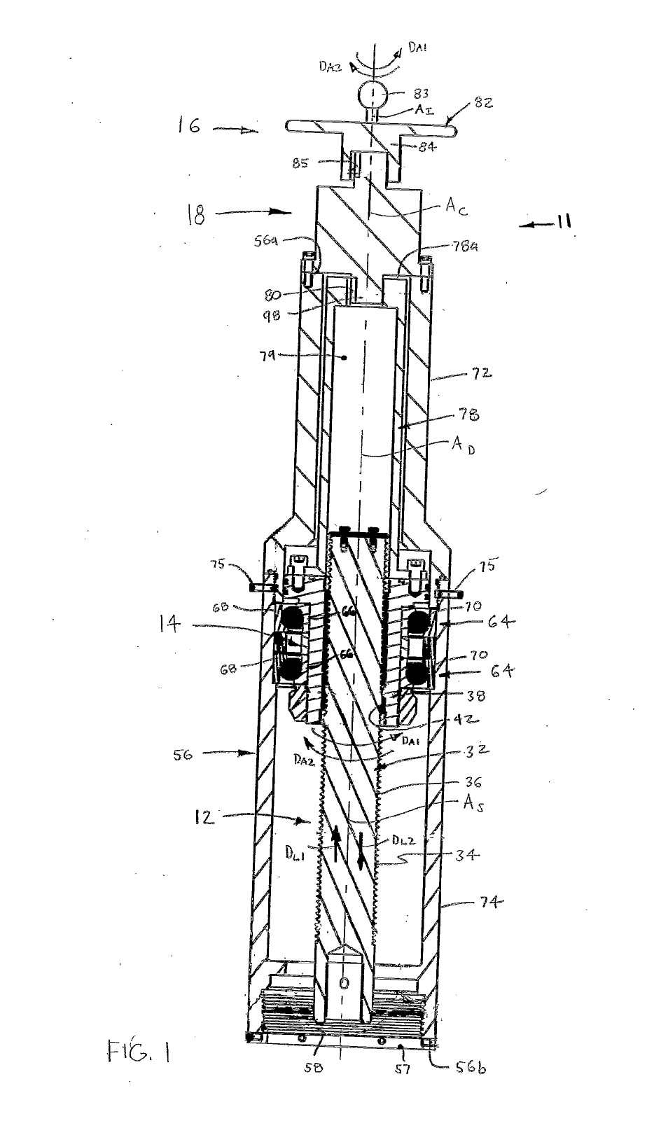

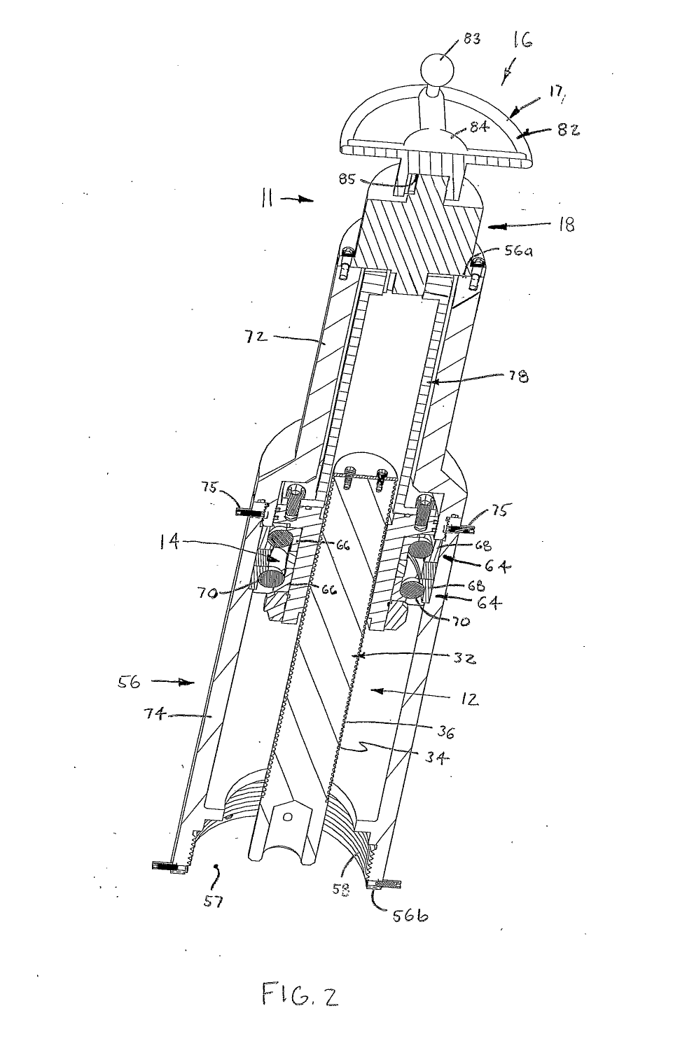

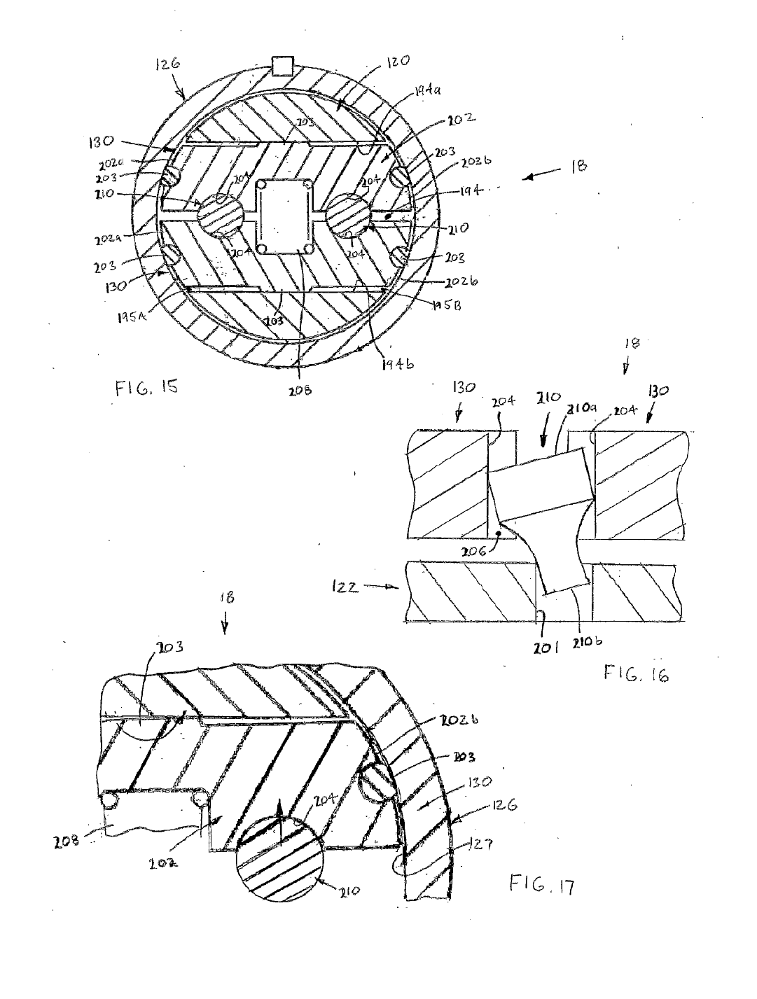

Referring now to the drawings in detail, wherein like numbers are used to indicate like elements throughout, there is shown in FIGS. 1-18 a high efficiency operator assembly 10 for a valve 1 for controlling flow through a flow passage P_{F}, in accordance with the present invention. The valve 1 includes a closure element 2 movable between a closed position V_{C} (FIG. 4B), at which the element 2 substantially obstructs the passage P_{F}, and an open position V_{O} (FIG. 4A). The operator assembly 10 basically comprises a movable stem 12, a stem driver 14, an input device 16 and a lock mechanism 11. The stem 12 has opposing first and second ends 12a, 12b, the first end 12a being connectable with the closure element 2 such that displacement of stem 12 moves the closure element 2 between the closed and open positions V_{C}, V_{O}. The stem driver 14 is rotatable about a central axis A_{D}, is engaged with the stem 12, and is configured to displace the stem 12 when the driver 14 angularly displaces about the central axis A_{D}. The input device 16 is rotatable about a central axis A_{I} and preferably includes a handle 17, as described below. Further, the lock mechanism 11 is operatively engageable with the stem 12, the stem driver 4, or the input device 16 so as retain the closure element 2 at about particular position when the input device 16 remains generally at a particular angular position about the input axis A_{I}.

In a first construction shown in FIGS. 10-13, the lock mechanism 11 includes a lockable drive assembly or clutch 18 configured to operatively couple the input device 16 with the stem driver 14 such that rotation of the input device 16 rotates the stem driver 14 about the driver axis A_{D}, thereby displacing the stem 12 as described in detail below. The clutch 18 is also configured to substantially prevent angular displacement of the stem driver 14 when the stem applies torque to the driver 14 while the input device 16 remains generally at a particular angular position about the input axis A_{D}, i.e., when the handle 17 is not being turned. Thus, the clutch 18 is preferably a “backstopping” clutch configured to substantially prevent displacement of the stem 12 when fluid pressure is applied to the closure element 2, i.e., the clutch 18 prevents “backdriving” of the input device 16 and the operator elements interposed between the closure element 2 and input device 16, as discussed in further detail below.

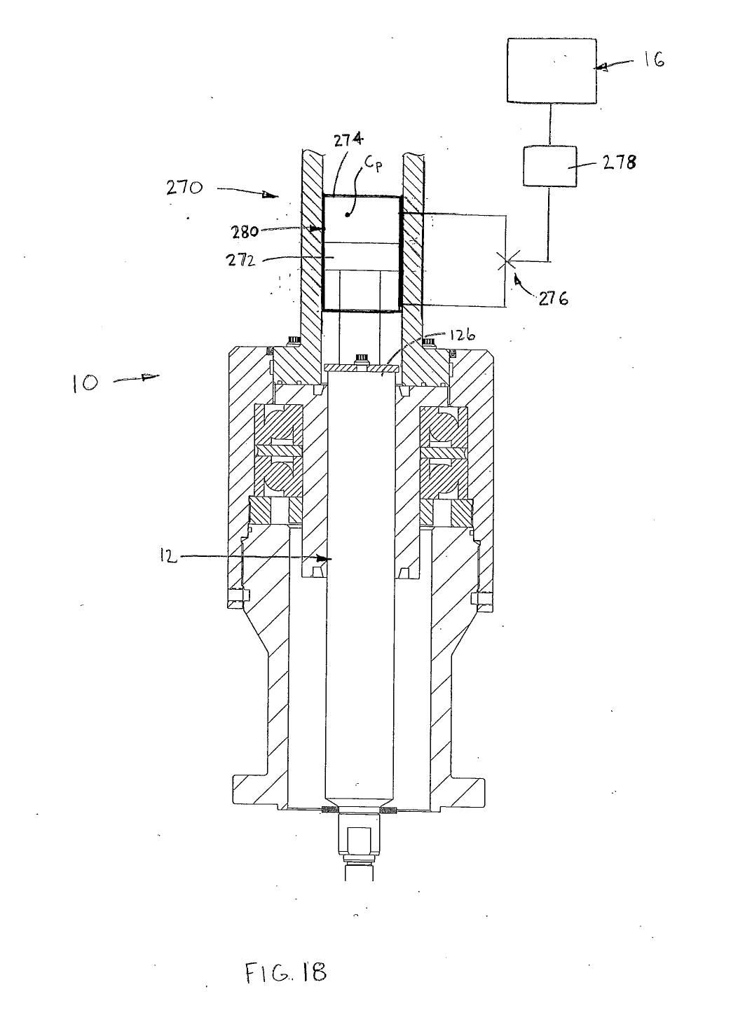

Referring to FIG. 18, in a second embodiment, the lock mechanism 11 includes a hydraulic assembly 270 configured to exert fluid pressure on the stem 12, the stem driver 14 or the input device 16 so as to releasably retain the one of the stem 12, the stem driver 14 and the input device 16 when the input device 16 is non-operational, i.e., remains generally at a particular angular position about the input axis A_{I}, as will also be described in greater detail below.

Referring now to FIGS. 1-4, the stem 12 is preferably linearly displaceable along a stem axis A_{S} and the lock mechanism 11 is configured to releasably retain the stem 12 at about a fixed linear position (e.g. S_{C}, indicated in FIG. 4A) along the stem axis A_{S} when the input device 16 remains generally at a particular angular position about the input axis A_{I}. Alternatively, the lock mechanism 11 may be configured to releasably retain the stem 12 at a fixed angular position about the stem axis A_{S} when the stem 12 is constructed to be substantially rotatable (i.e., and not linearly displaceable) about the axis A_{S}. Further, with the preferred lock mechanism 11 formed as a clutch 18, the clutch 18 is preferably “bi-directional” or capable of turning or rotating the stem driver 14 in opposing angular directions D_{A1}, D_{A2} to correspondingly linearly displace the stem 12 in opposing linear directions D_{L1}, D_{L2}, respectively, in response to the input device 16. In other words, the clutch 18 is configured such that rotation of the input device 16 in the first angular direction D_{A1} rotates the stem driver 14 in the first angular direction D_{A1}, so as to thereby linearly displace the stem 12 in the first direction D_{L1} along the stem axis A_{S}. Alternatively, rotation of the input device 16 in a second, opposing angular direction D_{A2} rotates the stem driver 16 in the second direction D_{A2} to linearly displace the stem 12 in the second, opposing direction D_{L2} along the stem axis A_{S}.

Although not presently preferred, the preferred clutch 18 may alternatively be constructed so as to be “uni-directional” or “one-way” and configured to only rotate the stem driver 14 in a single direction D_{A1} or D_{A2}; in such constructions, the closure element 2 is only moved in single direction (i.e., opened or closed) by the input device 16, such that the operator 10 requires other means to move the element 2 in the opposing direction.

Referring to FIGS. 10-13, in a first preferred construction, the clutch 18 comprises an input member 20 coupled with the input device 16, a clutch member 22, and an output member 24 coupled with the stem driver 14. The input member 20 is rotatable about a central axis A_{C} substantially collinear with the input and driver axes A_{I}, A_{D} and has inner and outer axial ends 20a, 20b. The clutch member 22 is fixed with respect to the axis A_{C} and is preferably provided as an integral portion of a generally tubular housing, as described below. Further, the output member 24 has inner and outer axial ends 24a, 24b and is slidably coupled with the stem driver 14 such that the output member 24 is displaceable along the axis A_{C} relative to the stem driver 14 and angular displacement of the output member 24 angularly displaces the stem driver 14. The output member 22 is releasably engageable with the clutch member 22 so as to substantially prevent angular displacement of the output member 24, thereby preventing angular displacement of the stem driver 14. Also, the output member 22 has at least one and preferably a plurality of drive surfaces 26 each located proximal to the inner end 24a and extending circumferentially and axially with respect to the central axis A_{C}.

The input member inner end 20a is operatively engageable with the output member drive surface(s) 26 such that angular displacement of the input member 20 axially displaces the output member 24 out of engagement with the clutch member 22 and then angularly displaces the output member 24 about the central axis A_{C} to rotate the stem driver 14. Preferably, the clutch 18 further comprises a biasing member 28 configured to bias the output member 24 toward clutch member 22, so that the output member 24 engages with the clutch member 22, and toward the input member 20 to maintain engagement of the input member 20 with the output member drive surface(s) 26. The biasing member 28 is preferably formed as stack of spring washers 28a, but may be formed in any other appropriate manner (e.g., one or more coil springs, an compressible elastomeric member, etc.). Further, the clutch member 22 preferably includes a friction “stop” surface 23 and the output member 24 includes a mating friction “retention” surface 25 frictionally engageable with the clutch member stop surface 24 so as to prevent angular displacement of the output member 24, and thus also the stem driver 14.

Most preferably, the clutch 18 further includes a housing 29 having opposing ends 29a, 29b and a central bore 30 extending between the ends 29a, 29b. The input and output members 20, 24 are disposed at least partially within the bore 30 and the clutch friction surface 23 is provided by an inner circumferential surface section 31 at least partially defining the housing bore 30. Preferably, the clutch inner circumferential surface 31 tapers axially so as to be generally conical and the output member 24 has an outer circumferential surface 27 tapering axially so as to be generally conical and providing the friction surface 25. With this structure, the output member 24 is at least partially disposeable within the clutch member 22 such that the output member outer surface 25 engages with the clutch member inner surface 23, the mating tapering surfaces 23, 25 thus “interlocking” in a wedge-like manner to prevent displacement of the output member 24.

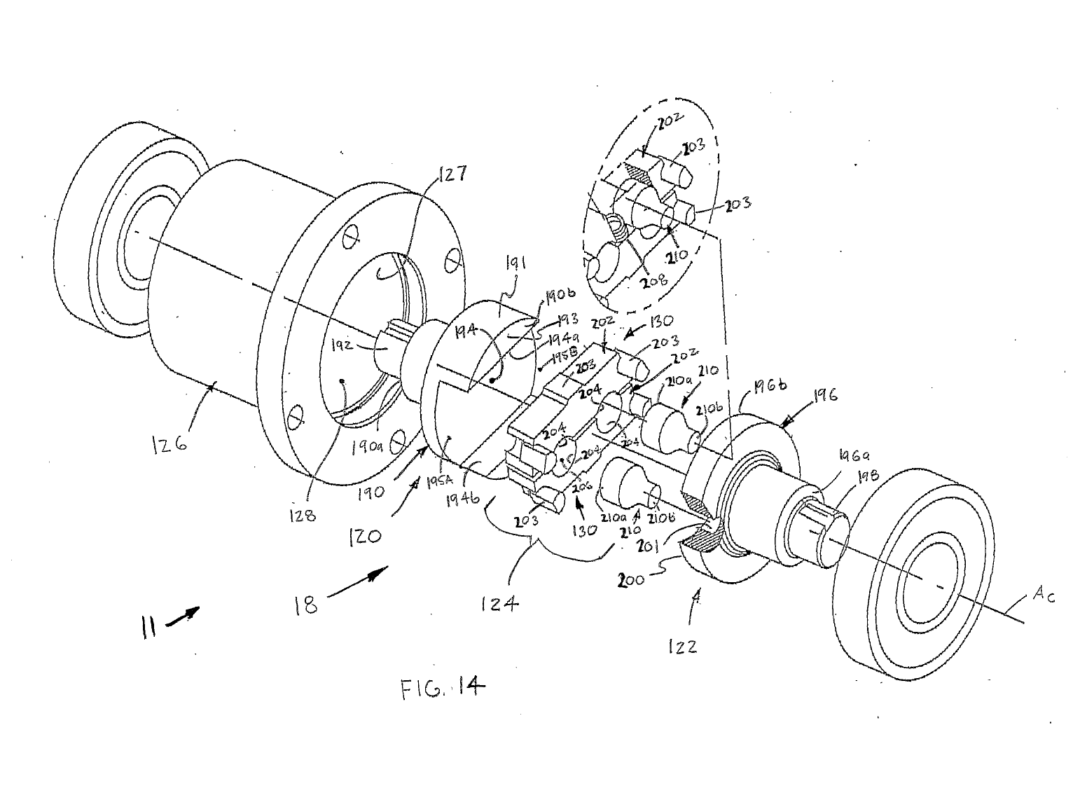

Referring to FIGS. 14-17, in a second preferred construction, the clutch 18 has a central axis A_{C} substantially collinear with the input and driver axes A_{I}, A_{D} and includes an input member 120, an output member 122 and a coupler 124. The input member 120 is connected with the input device 16 and is rotatable about the clutch axis A_{C}, and the output member 122 is connected with the stem driver 14 and is also rotatable about the clutch axis A_{C}. Further, the coupler 124 is configured to operatively couple the input member 120 with the output member 122 such that the input member 120 rotatably drives the output member 122 to rotate about the clutch axis A_{C} so as to angularly displace the stem driver 14 about the driver axis A_{D} when the input device 16 angularly displaces about the input axis A_{I}. The coupler 124 is further configured to substantially prevent angular displacement of the input member 120 when the output member 122 angularly displaces relative to the input member 120.

Preferably, the second embodiment clutch 18 further includes a housing 126 having an inner circumferential surface 127 defining a bore 128, and the input and output members 120, 122 and the coupler 124 are each disposed at least partially with the housing bore 128. With such an arrangement, the clutch coupler 124 preferably includes at least one and preferably two movable brake members 130 configured to releasably frictionally engage with the housing inner surface 127 when the output member 122 angularly displaces relative to the input member 120. The frictional engagement of the one or more brake members 130 retains the input and output members 120, 122 generally at a particular angular position about the clutch axis A_{C}, thereby releasably retaining the directly connected stem driver 14 and input device 16 and preventing linear displacement of the stem 12, as described in greater detail below.

Referring now to FIGS. 1-9, the stem 12 preferably includes an elongated circular cylindrical bar 32 having an outer circumferential surface 34 and at least one exterior thread 36 formed in the outer surface 34. The stem driver 14 preferably includes a generally circular cylindrical body 38 with an inner circumferential surface 40 defining a central bore 42 and at least one interior thread 44 is formed in the inner surface 40. The driver body 38 is disposed coaxially about a portion of the stem bar 32 such that the bar 32 extends through the bore 42, and thus the driver and stem axes A_{D}, A_{S} are substantially collinear. The driver interior thread 44 is operatively coupled with the stem exterior thread 36 such that rotation of the stem driver 14 simultaneously angular displaces the stem bar 32 about the stem axis A_{S} and also linearly displaces the bar 32 along the stem axis A_{S}, thereby moving the closure element 2 between the open and closed positions V_{O}, V_{C}.

Preferably, the stem 12 and stem driver 14 are constructed as components of a “low torque” actuator 15 such that the driver 14 further includes intermediate elements for transmitting torque from the driver 14 to the stem 12. Most preferably, the stem 12 and stem driver 14 form a “ball screw” actuator 15 that further includes a plurality of balls 46 disposed between the stem driver interior thread 44 and the stem exterior thread 36, as depicted in FIG. 8. As such, rotation of the stem driver 14 causes each ball 46 to roll simultaneously within an inner helical groove 48 defined between adjacent sections of the stem driver interior thread 44 and within an outer helical groove 49 defined between adjacent sections of the stem exterior thread 36, which transmits torque from the driver 14 to the stem 12. Alternatively, the stem 12 and driver 14 may be constructed to form a “roller screw actuator” that further includes a plurality of threaded rods 50 spaced circumferentially about the driver axis A_{D} and rotatably connected with the stem driver body 38, as shown in FIG. 9. Each rod 50 has a central axis A_{R} and an exterior thread 52 simultaneously engaged with the driver interior thread 44 and with the stem exterior thread 36. As such, rotation of the stem driver body 38 rotates each rod 50 about the associated rod central axis A_{R} and in certain constructions, may also linearly displace each rod 50 generally parallel with the driver axis A_{D} (structure not shown).

Although the stem driver 14 preferably includes intermediate torque-transmitting elements (e.g., balls 46 or rollers 50) to provide a low torque actuator 15, it is within the scope of the present invention to directly threadably engage the stem interior thread(s) 44 with the stem exterior thread(s) 36 in the manner of a standard “acme screw”. In such constructions, the stem 12 and/or the stem driver 14 preferably include means for reducing friction between the threads 36 and 44, such as for example, by constructing the driver 14 to contain a lubricating fluid so as to form a “hydrostatic actuator” or to form the threads 36, 44 as of a reduced friction. Such friction reducing means are generally necessary to reduce torque requirements as the actuator 15 is otherwise relatively low efficiency and would require a gear box or other mechanism to reduce operator effort required to actuate the valve 1. As a further alternative, the stem driver 14 may be formed such that driver axis A_{D} is spaced from the stem axis A_{S}, such that the two axes A_{D}, A_{S} are parallel, perpendicular or skewed (none shown), and the driver 14 has an exterior thread (not shown) that engages the stem exterior thread 36, for example in the manner of a worm gear drive. In any case, the scope of the present invention includes the various constructions of the stem 12 and the stem driver 14 described herein and all other appropriate constructions that enable the valve operator assembly 10 to function generally as described herein.

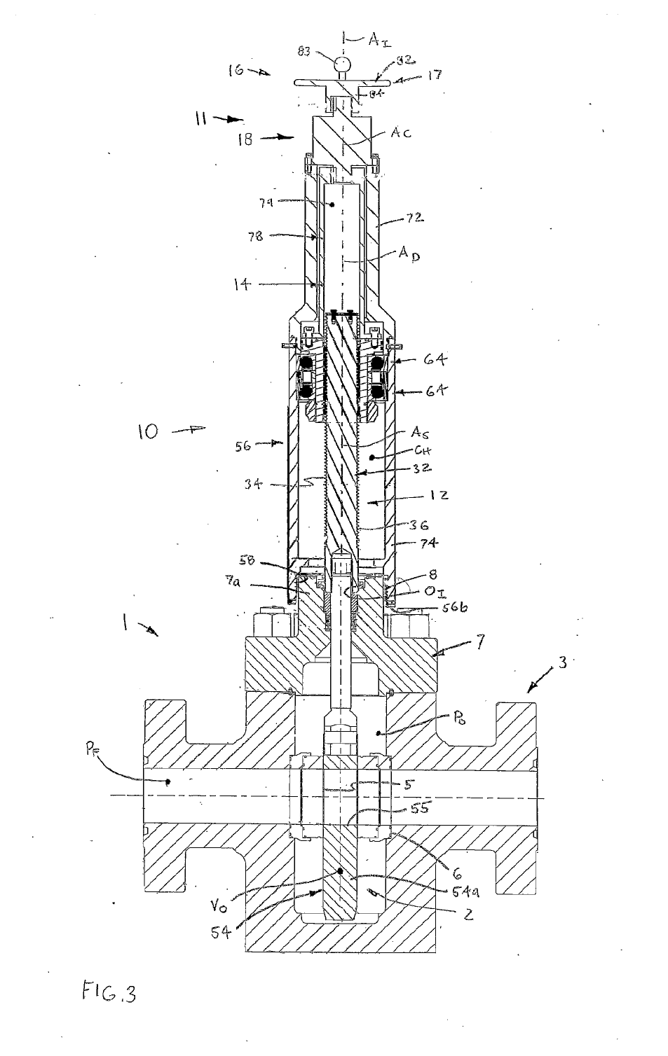

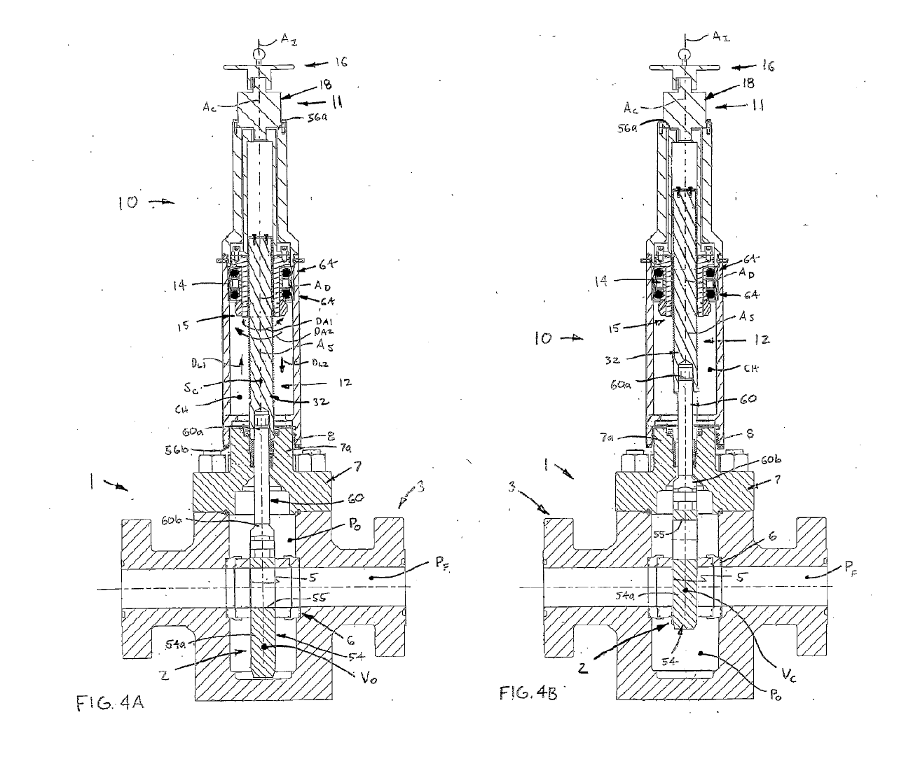

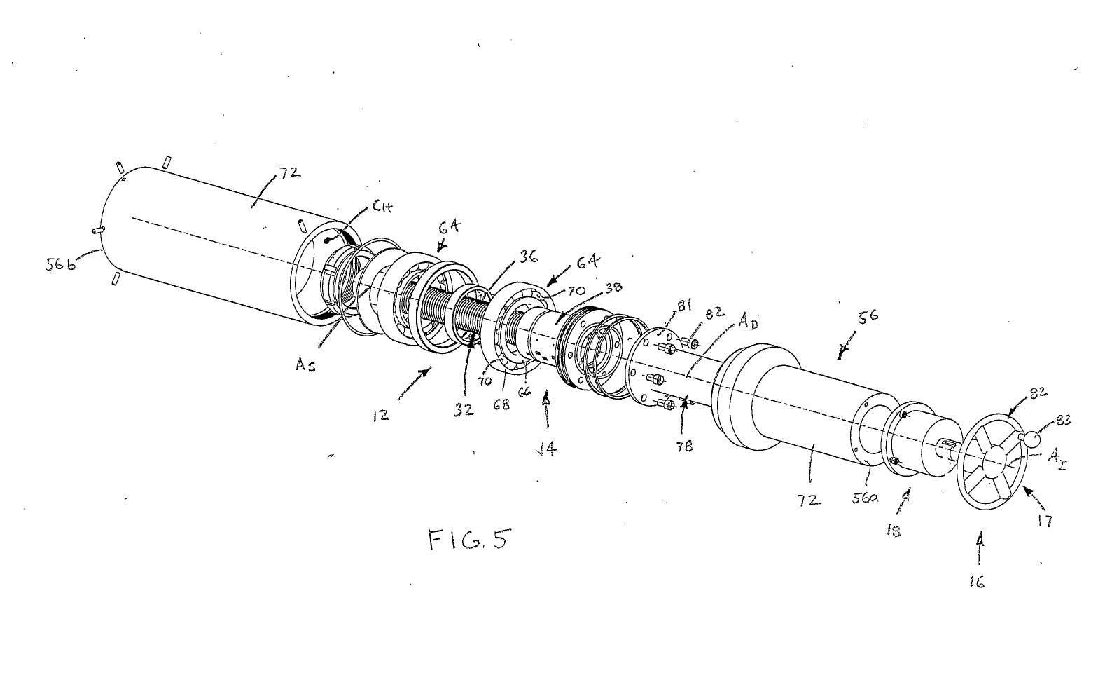

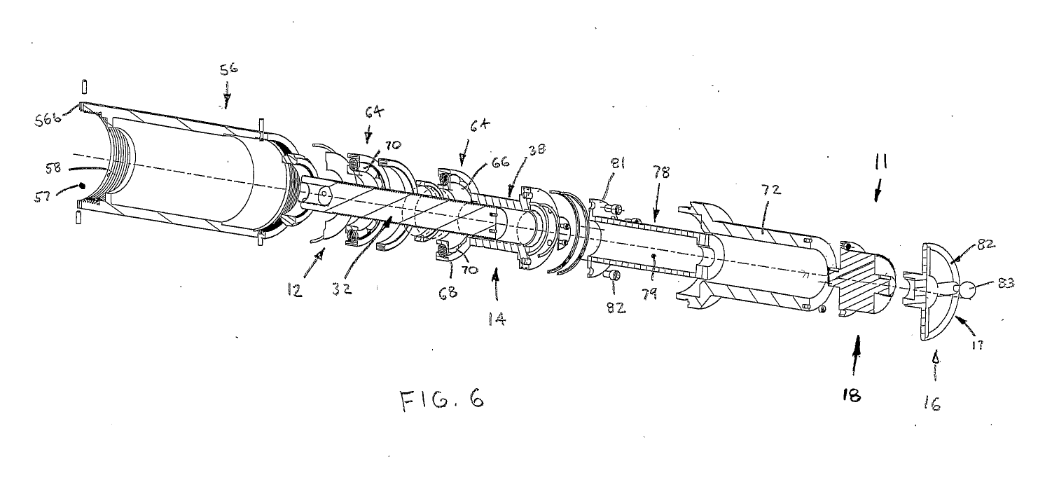

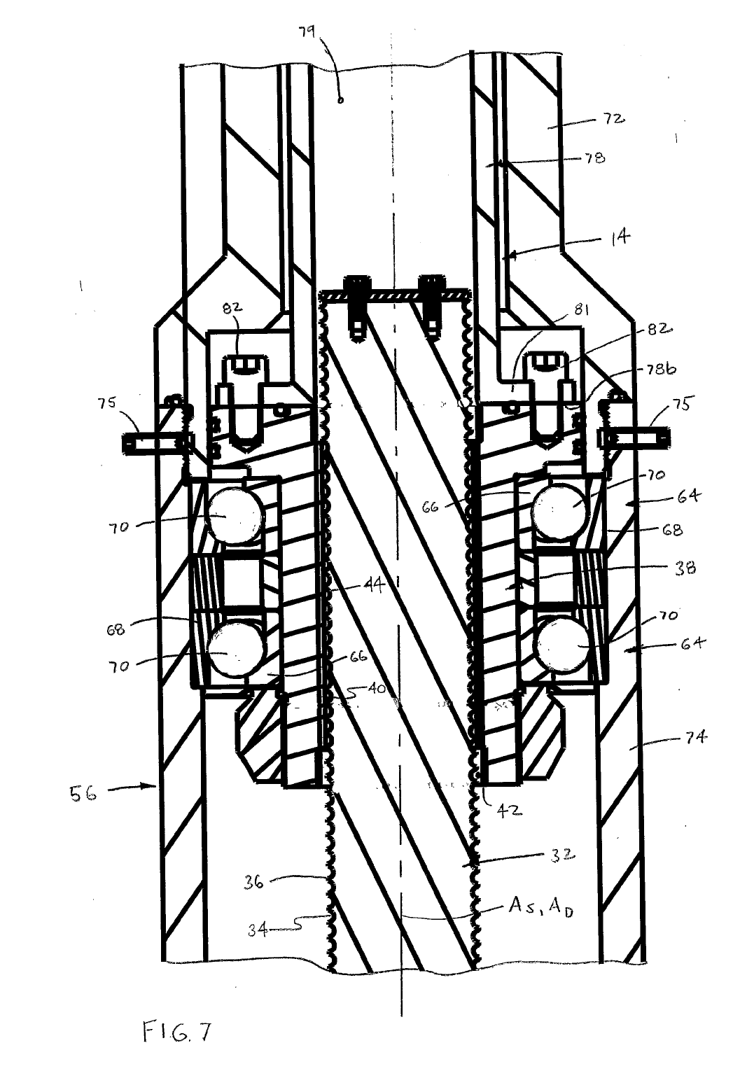

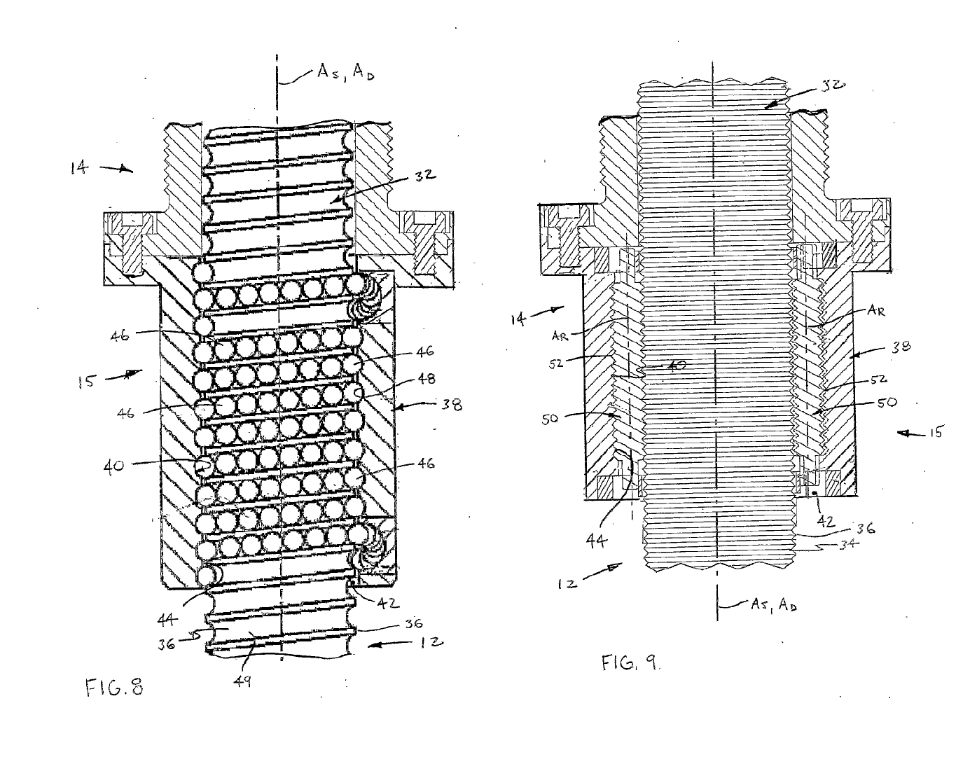

Referring to FIGS. 3 and 4, the valve 1 preferably includes a valve housing 3 having an interior surface providing a valve seat 5, preferably provided by a cylindrical insert 6, and at least partially defining the flow passage P_{F} and an operator passage P_{O}. The operator passage P_{O} extends generally perpendicularly to the flow passage P_{F}, and the closure element 2 is movable through the operator passage when moving between the closed and open positions V_{C}, V_{O}. As best shown in FIG. 3, the valve housing 3 preferably includes a bonnet portion 7 with an annular mounting section 7a providing an inlet opening O_{I} of the operator passage P_{O} and an exterior thread 8. Further, the valve 1 is preferably a “gate valve” such that the closure element 2 includes a gate member 54 having a through-hole 55 and at least one generally solid section 54a. With such an element 2, the gate member through-hole 55 is alignable with the flow passage P_{F} when the closure element 2 is disposed in the open position V_{O}, as shown in FIGS. 3 and 4A. Alternatively, the gate member solid section 54a extends across and substantially obstructs the passage P_{F} when the closure element 2 is disposed in the closed position V_{C}. However, the valve 1 may be any other type of valve, for example a ball valve, etc., and the scope of the operator assembly 10 of the present invention is no manner limited to any particular valve type or structure.

Referring to FIGS. 1-6, the valve operator assembly 10 preferably further comprises a generally tubular housing 56 having opposing ends 56a, 56b and an interior chamber C_{H}, the clutch 18, stem driver 14 and at least a portion of the stem 12 being disposed within the chamber C_{H}. The input device 16 and the clutch 18 are connected with the operator housing first end 56a and the operator housing second end 56b is connected with the valve housing 3. Preferably, the housing second end 56b includes an opening 57 with an interior thread 58 engageable with the bonnet thread 8 to releasably secure the operator housing 56 to the valve housing 3. Further, the stem 12 also includes an adapter bar 60 extending into the operator passage P_{O} and having a first end 60a attached to the stem bar 32 and a second end 60b connected with the closure element 2, specifically the gate member 54. The adapter bar 60 is configured to angularly displace relative to the gate member 54 such that when the stem 12 angularly and linearly displaces by action of the stem driver 14, the gate member 54 is substantially linearly displaced without angular displacement.

Referring now to FIGS. 4A and 4B, with the above-described structure, the valve operator assembly 10 basically functions as follows. When an operator desires to move the closure element between the closed and open positions V_{C}, Vₒ, the operator appropriately manipulates the input device 16, e.g., turns the handle 17, to cause the clutch input member 20 or 120 to rotate about the clutch axis A_{C}, which rotationally drives the output member 24 or 122 and the connected stem driver 14. Rotation of the stem driver 14 causes the stem 12 to linearly displace along (and rotate about) the stem axis A_{S}, which moves the closure element 2 toward the desired open or closed position V_{O}, V_{C}.

However, when the operator ceases manipulation of the input device 16 (e.g., stops turning the handle 17), pressure exerted by fluid within the valve flow passage P_{F} tends to bias the closure element 2 toward the closed position V_{C}, which thereby biases the stem 12 in the first, upward direction D_{L1} along the stem axis A_{S}. With the first embodiment clutch 18 depicted in FIGS. 10-13, the biasing force on the stem 12 is balanced by the reactionary forces generated at the engagement interface between the output member 24 with the clutch member 22, specifically friction between the preferred clutch and output member surfaces 23, 25, such that the closure element 2 is held stationary and does not displace. Alternatively, with the second embodiment clutch 18 shown in FIGS. 14-17, the biasing force causes the stem 12 to displace a relatively small distance along the axis A_{S} and exert a back-driving torque on the stem driver 14, which displaces the output member 122 a relatively small angular distance about the clutch axis A_{C}. The angular displacement of the clutch output member 122 relative to the input member 120 causes the brake member 130 to displace into engagement with the clutch housing inner surface 127, as described in detail below, thereby preventing further displacement of the output member 22 and connected stem driver 14. By retaining the stem driver 14 at a particular angular position about the driver axis A_{D}, the stem 12 is held at a particular position along the stem axis A_{S}, thereby releasably retaining or “locking” the closure element 2 at a particular position.

Thus, in all embodiments, the clutch 18 basically functions to normally lock the valve operator assembly 10, and thus the valve closure element 2, when the input device 16 is not being manipulated or used by an operator. As such, the operator assembly 10 enables low torque operation without requiring a separate balance stem to prevent back driving of the operator assembly 10. The elimination of the balance stem reduces the required size of the valve housing 3, reduces potential leakage paths, increases valve reliability, and enables the use of the valve 1 in subsea applications, which was impossible with certain prior art stem-balanced gate valves. Having described the basic elements and functioning above, these and other elements of the operator assembly 10 of the present invention are described in detail below.

Referring now to FIGS. 1-7, the valve operator assembly 10 preferably further comprises at least one bearing 64 configured to rotatably support the stem driver 14 within the operator housing 56. Most preferably, the operator assembly 10 has two bearings 64 spaced apart along the driver axis A_{D} and each bearing 64 is a preferably a rolling element bearing, but may alternatively be any other type of bearing (e.g., a plain or journal bearing, etc). Specifically, each bearing 64 preferably includes an inner annular member 66 disposed about the stem driver body 38, an outer annular member 68 disposed about the bearing inner member 66 and connected with the housing 56, and a plurality of rolling elements 70 disposed between the inner and outer members 66, 68. Further, the operator housing 56 preferably includes a first, radially smaller tubular section 72 providing the housing first end 56a and a second, radially larger tubular section 74 connected with the first section 72 and providing the housing second end 56b. The first housing section 72 is sized to receive a stem driver connector 64, as described below, and the second housing section 74 is sized to receive the bearings 64, the stem driver body 38, and at least a substantial portion of the stem 12. Preferably, the two housing sections 72, 74 are releasably connected by a plurality of threaded fasteners 75, but may be removably coupled by any other appropriate means or even fixedly or non-removably connected.

Still referring to FIGS. 1-7, the stem driver 14 preferably further includes an elongated tubular connector 78 having a first end 78a connected with the clutch 18, specifically the output member 22, a second end 78b connected with the driver cylindrical body 38, and a central bore 79 extending generally between the first and second ends 78a, 78b. With this structure, torque is transmitted from the clutch 18 to the stem driver 14 through the connector 78 and at least a portion of the stem 12 is displaceable within the connector bore 79 when the stem 12 linearly displaces along the stem axis A_{S}, as best shown in FIGS. 4A and 4B. With the first clutch construction, the upper end 78a of the connector 78 is preferably disposed within a bore 114 of the clutch output member 24, as described below. Alternatively, with the second clutch construction, the connector upper end 78a has a coupler opening 80 sized to receive a coupler shaft 198 of the clutch member 18, as described below. Further, the connector lower end 78b has an annular mounting flange 81 fastened to the stem driver body 38 by a plurality of threaded fasteners 82.

Referring to FIG. 1, the handle 17 of the input device 16 is preferably formed as a hand wheel 82 connected with and configured to manually rotate the clutch 18 so as to angularly displace the stem driver 14 and a knob 83 attached to the wheel 82. Preferably, the hand wheel 82 includes a central hub 84 with a cavity 85 configured to receive a coupler shaft 192, described below, of the clutch input member 20 or 120. Although a circular hand wheel 82 is presently preferred, the input device 16 may be formed in any appropriate manner that enables an operator to manually operate the valve operator assembly 10, such as for example, as a lever, etc.

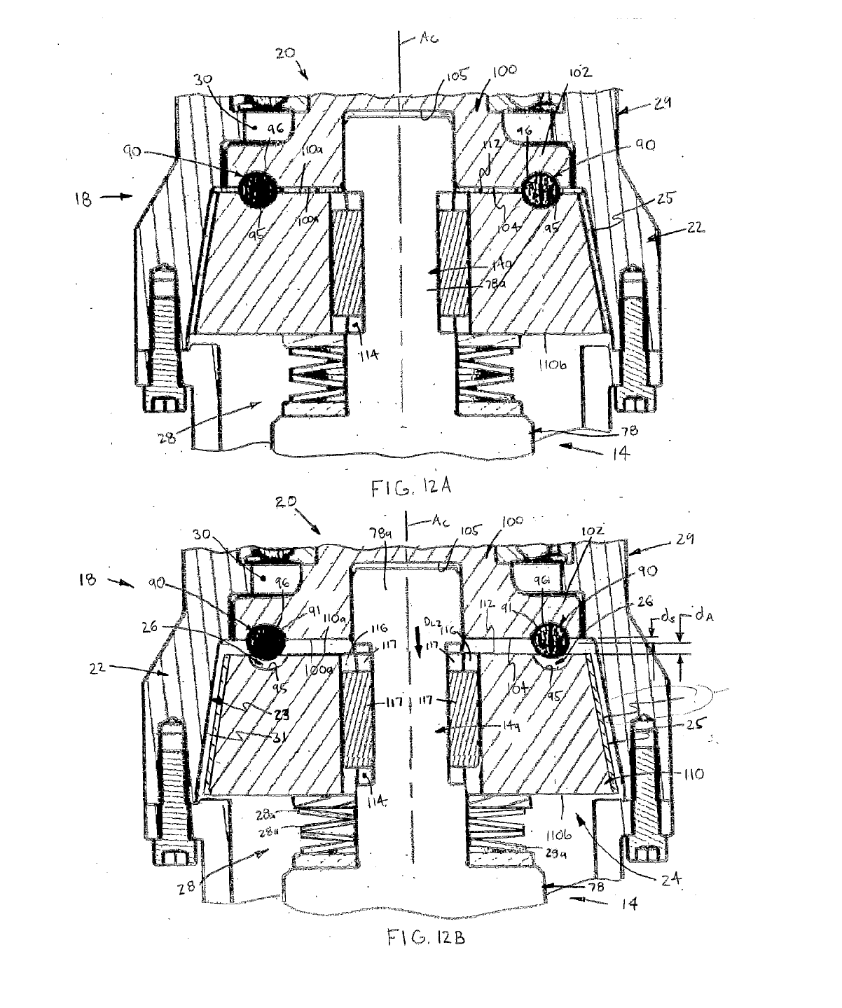

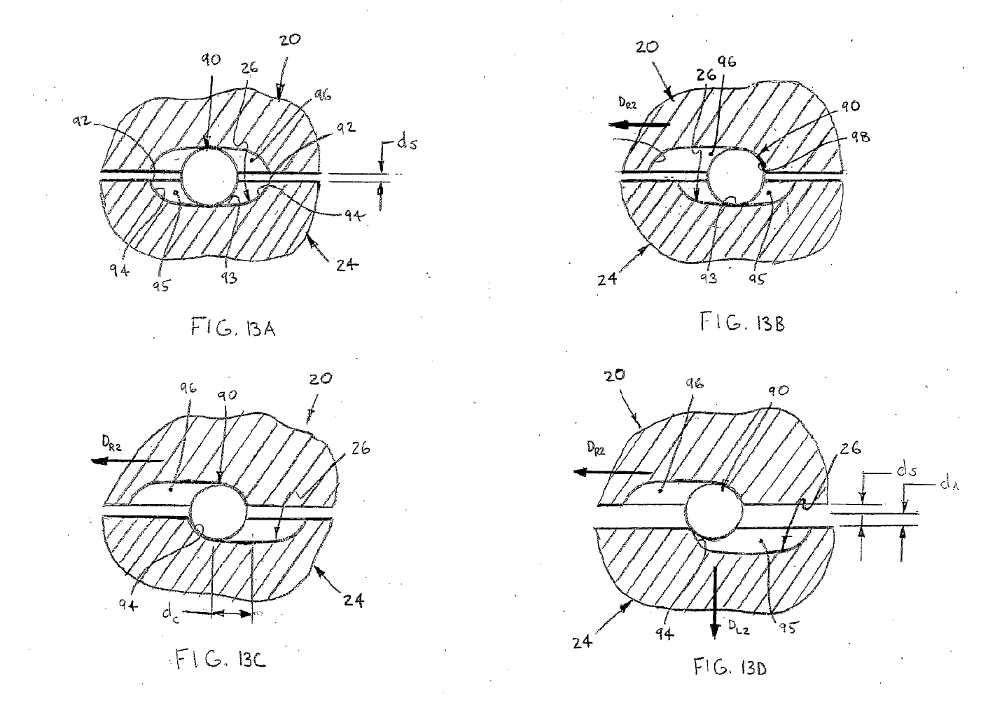

Referring now to FIGS. 10-13, the preferred construction of the clutch 18 preferably further comprises at least one transfer member 90 disposed generally between the input and output members 20, 24 and against the at least one drive surface 26. Most preferably, the output member 24 includes a plurality of the drive surfaces 26 spaced circumferentially about the central axis A_{C} and the clutch 18 includes a plurality of the transfer members 90 each disposed against a separate one of the drive surfaces 26. Each transfer member 90 is configured such that angular displacement of the input member 20 pushes the transfer member 90 against the output member drive surface 26, causing the transfer member 90 to displace a circumferential distance d_{C} (see FIG. 13C) along the drive surface 26 until the output member 24 displaces axially a sufficient distance d_{A} to disengage from the clutch member 22. Thereafter, further angular displacement of the input member 20 pushes the output member 24, through the transfer member(s) 90, to angularly displace about the central axis A_{C}. Preferably, each transfer member 90 includes a spherical body 91, so as to be generally formed as a ball, and is rollable and/or slidable along the associated drive surface 26, but may be formed in any other appropriate manner (e.g., as a circular disc, a square lug, etc.).

Further, each drive surface 26 has opposing ends 92 located generally at the inner end 24a of the output member body 110 and a central section 93 spaced axially from the body inner end 16a. Preferably, each drive surface 26 is formed as a generally continuous surface further having two opposing curved sections 94 each extending between the central section 93 and a separate one of the surface ends 92, as indicated in FIG. 13A. With this structure, the output member 24 displaces axially when the input member 20 forces the transfer member(s) 90 to displace generally from the drive surface central section 93 and towards one of the drive surface ends 92, as described in greater detail below.

Although the preferred construction of the clutch 18 preferably includes one or more transfer members 90 through which the input member 20 rotatably drives the output member 24, the clutch 18 may alternatively be constructed without any transfer members. In such an alternative construction, the inner end 20a of the input member 20 is formed to directly drivingly engage with the output member drive surfaces 26. For example, the input member 20 may have one or more projections or teeth (structure not shown) which are directly slidably disposed against the output member drive surface(s) 26. Similarly to the structures having the transfer members 90, the initial rotation of the input member 20 causes the sliding teeth to first push the output member 24 axially out of engagement with the clutch member 22, and then pushes the output member 24 circumferentially to rotate about the axis A_{C}.

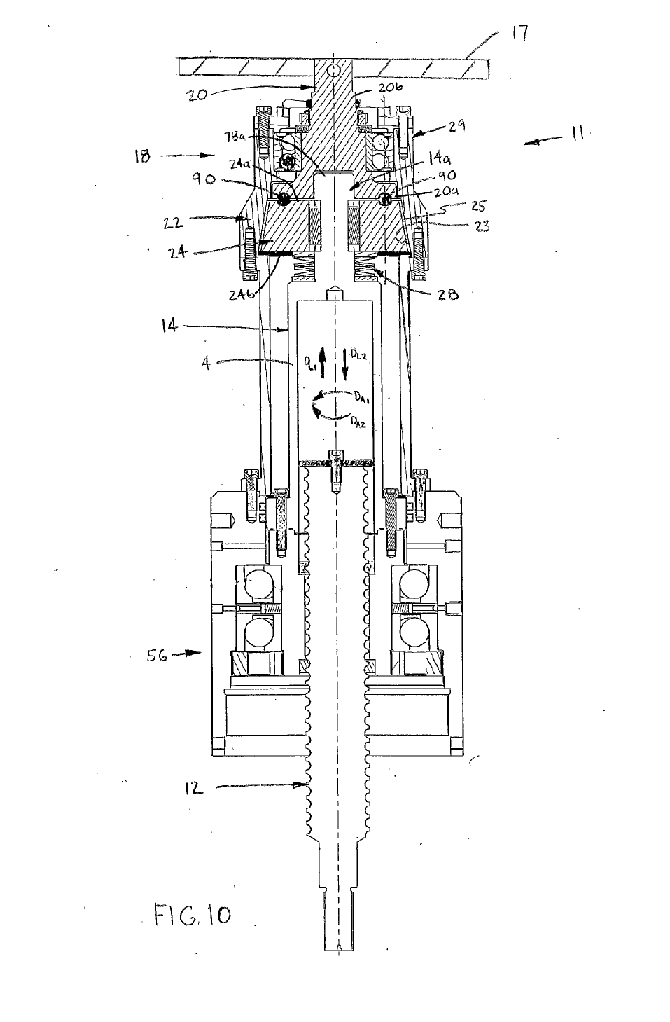

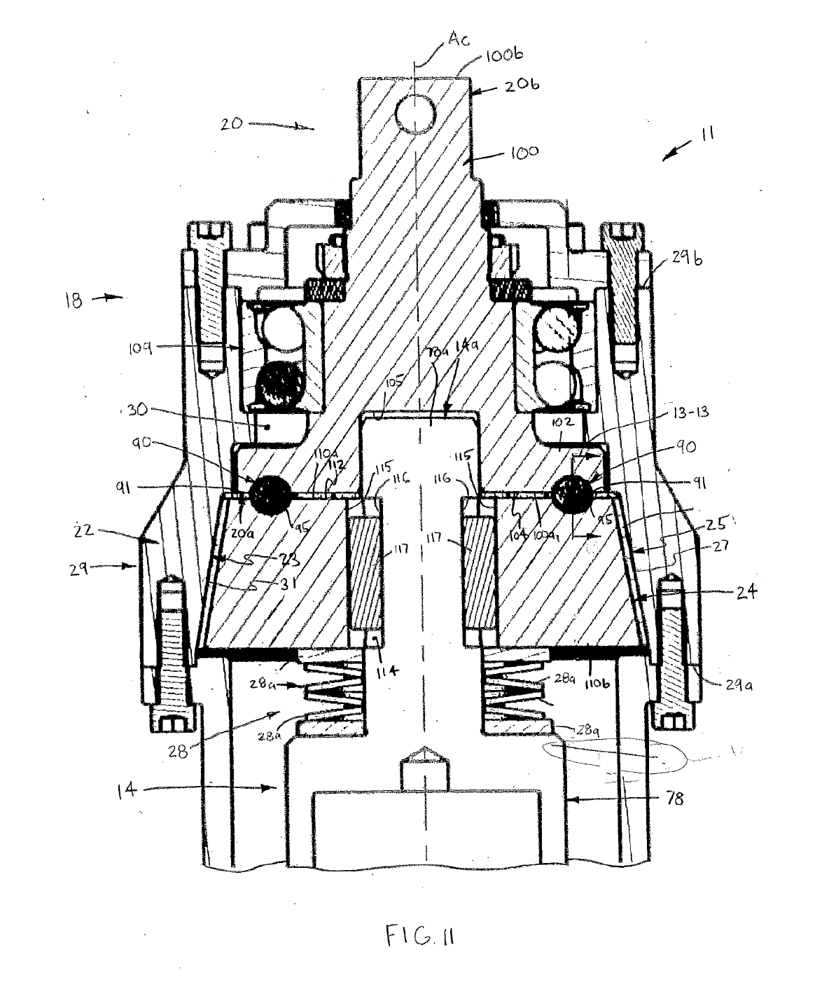

Referring now to FIGS. 12 and 13, the preferred continuous drive surfaces 26 are each preferably provided by a generally elliptical cavity 95 extending axially from a radial end surface 112 of the output member 24, as described below, and partially circumferentially about the central axis A_{C}. The input member 20 preferably includes a radial end surface 104 generally facing and spaced axially from the output member end surface 112 by a spacing distance dₛ (see FIGS. 12B and 13A) and has at least one and preferably a plurality of cavities 96, each extending axially from the end surface 104 and partially circumferentially about the central axis A_{C}. The input member cavities 96 are spaced apart about the central axis A_{C} and each is generally aligned with a separate one of the output member cavities 95. Further, each one of the transfer members 90 is partially disposed within a separate one of the output member cavities 95, so as to be displaceable along the associated drive surface 26, and simultaneously partially disposed within the aligned input member cavity 96.

Referring to FIG. 13, with the preferred clutch construction, the input member 20 drives the output member 24 through the transfer members 90 in the following manner. When the clutch 18 is in a static or non-rotational state, each transfer member 90 will be located at some position on the drive surface central section 93, depicted generally in the middle thereof in FIG. 13A but may be located toward either end 92. In any case, when the input member 20 begins to rotate, for example in the second angular direction D_{R2} as shown in FIG. 13, the input member 20 must first angularly displace relative to the output member 24 until an end section 98 of the input member cavity 96 contacts the transfer member 90, as shown in FIG. 13B. The input member 20 then continues to angularly displace relative to the output member 24 while pushing the transfer member 90 to roll or/and slide toward one axial end 92 of the drive surface 26 within the particular output member cavity 95, as shown in FIG. 13C. As the input member 20 pushes the transfer member 90 to displace along one curved section 94 of the drive surface 26, the output member 24 is pushed axially outwardly in the second linear direction Dᵤ away from the input member 20, which is fixed axially as described below.

Once the output member 24 displaces an axial distance d_{A} (FIGS. 12 B and 13D) sufficient to disengage the output member friction surface 25 from the clutch friction surface 23 (FIG. 12B), the input member 20 will continue to push the output member 24 (i.e., through the transfer member(s) 90) to angularly displace about the central axis A_{C}, thereby rotating the stem driver 14. However, once the input member 20 stops rotating, the biasing member 30 will bias or push the output member 24 in the first linear direction D_{L1} toward the input and clutch members 20, 22, until the output member retention surface 25 reengages with the clutch member stop surface 23, as described above. Also, the movement of the output member 24 toward the input member 20 causes each transfer member 90 to be pushed from the curved section 93 of the drive surface 26 and onto the drive surface central section 93. Although described and depicted for angular displacement of the input member 20 in the second angular direction D_{R2}, the input member 20 may drive the output member 24 (and thus the stem driver 14) to rotate in the first angular D_{R1} in a substantially similar manner.

Referring to FIGS. 11 and 12, the input member 20 preferably includes a generally elongated cylindrical body 100 with opposing inner and outer ends 100a, 100b and an annular flange 102 at the inner end 100b. The flange 102 provides a generally annular radial end surface 104, the transfer member cavities 95 being formed in the end surface 104 as described above. Further, the body 100 has a central circular pocket 105 extending inwardly from the inner end 100a and is configured to receive an end of the stem driver 14, as described below. Furthermore, the outer end 100b is preferably configured to mount a handle 17, as discussed above. Preferably, the cylindrical body 100 is rotatably supported within the preferred housing 29 by a bearing 109, most preferably a double-row ball bearing, disposed within the housing bore 30 such that the input member 20 is rotatable, but axially fixed.

Still referring to FIGS. 11 and 12, as discussed above, the output member 24 preferably includes a generally circular cylindrical body 110 having inner and outer axial ends 110a, 110b and providing the tapering outer circumferential surface 25, as described above. The body 110 has a radial end surface 112, the transfer member cavities 95 extending inwardly therefrom as discussed above, and a central bore 114 extending between the body axial ends 110a, 110b. The bore 114 is configured to receive the coupler portion 14a of the stem driver 14, specifically the connector upper end 78a as discussed above, such that the cylindrical body 110 is axially displaceable along the stem driver portion 14a. Specifically, the bore 114 and the connector upper end 78a each have aligned axial slots 115, 116 and a key 117 is disposed within each pair of slots 116, 117 so as to permit axial displacement of the body 110 on the coupler portion 14a of the stem driver 14, as indicated in FIGS. 11 and 12.

Referring now to FIGS. 14-17, the alternative construction clutch 18 is preferably formed as a “formsprag” type of backstopping clutch, with the input and output members 120, 122 and the coupler 124 being formed with the following presently preferred structures. Specifically, the clutch input member 120 preferably includes a stepped circular cylindrical body 190 having opposing axial ends 190a, 190b and an outer circumferential surface 191. The body 190 has a coupler shaft 192 engageable with input device 16 at the outer axial end 90a and a radial end surface 193 at the inner end 90b. A slotted opening 194 extends generally axially from the end surface 193 and generally radially through the input member 120. Preferably, the slotted opening 194 is at least partially defined by a pair of facing, generally parallel inner surfaces 194a, 194b extending generally radially through the input member 120 so as to define opposing radial openings 195A, 195B in the outer surface 191. Further, the output member 122 preferably includes a stepped circular cylindrical body 196 having opposing axial ends 196a, 196b, a coupler shaft 198 engageable with the stem driver 14 at the outer end 196a, and a radial end surface 200 at the inner end 96b. At least one and preferably two cavities 101 each extend generally axially from the end surface 200 and into the body 196.

Furthermore, each brake member 30 preferably includes a generally rectangular bar 202 having a central pivot section 203. Each bar 202 is disposed within the input member slotted opening 194 so as to extend generally radially and has opposing ends 202a, 202b each disposed within a separate one of the input body radial openings 195A, 195B and a shoe 103 mounted at each end 202a, 202b. Preferably, each brake member bar 202 has a pair of spaced apart, semicircular notches 204 and the two brake members 30 are arranged such that each notch 204 is aligned with a separate one of the notches 204 of the other brake member 130 to define one of a pair of openings 206, the purpose of which is described below. Also, the coupler 124 preferably includes a spring 208 configured to bias the two bars 202 apart and generally against a separate one of the slotted opening inner surfaces 194a or 194b.

Preferably, the clutch coupler 124 also includes at least one and most preferably two, radially spaced apart pins 210 coupling the input and output members 120, 122 through the brake member(s) 30. Each pin 210 has a tapered cylindrical body 212 with a first, radially larger end 212a and a second, radially smaller end 212b. Further, each pin first end 212a is engageable with the brake member(s) 30, and preferably disposed within a separate one of the openings 106 defined between the bars 202, and each pin second end 212b is disposed within one of the output member cavities 201.

With the above-described structure, the coupler 124 is configured such that rotation of the input member 120 rotatably drives the output member 122 through the brake member(s) 130 and the pin(s) 210. That is, as the input member 120 rotates, each brake member 130 is carried by the input member 120 and pushes against the first end 210a of one pin 210, which in turn causes the output member 122 to be pushed/pulled by the pin second end 210b to rotate about the clutch axis A_{C}. However, when the output member 122 angularly displaces relative to the input member 120, each pin 210 pivots within the associated output member cavity 201 (see FIG. 16) so that the pin 110 pushes one brake member 30 to displace at least generally radially within the input member slotted opening 194 and into frictional engagement with the housing inner surface 127, as best shown in FIG. 13. More specifically, each bar 202 pivots within the slotted opening 194 about the bar pivot section 203 such that one end 202a or 202b moves within the associated radial opening 195A, 195B and wedges the associated shoe 203 against the housing inner surface 127. Thereby, the one or more brake members 130 releasably retain the input and output members 120, 122 at about a particular angular position about the clutch axis A_{C}.

Although the clutch 18 is preferably formed in either of the two preferred constructions described in detail above, the clutch 18 may be formed in any other appropriate manner that enables the valve operator 10 to function generally as described herein.

Referring now to FIG. 18, as discussed above, in the second embodiment, the lock mechanism 11 includes a hydraulic assembly 270 configured to exert fluid pressure on the stem 12, the stem driver 14 or the input device 16 so as to retain the closure element 2 at about a particular position when the input device 16 is non-operational. For example, the hydraulic assembly 270 may include a piston 272 attached with the stem 12 (or the stem second end 12b may provide the piston 272 (structure not shown)), a housing 274 providing at least one pressure chamber C_{P}, the piston 272 being disposed within the housing 274, a control valve 276 controlling flow through the chamber C_{P}, and a valve actuator 274 configured to operate the control valve 276 in response to operation of the input device 16. In such an arrangement, the control valve 276 is normally closed to retain fluid within the pressure chamber C_{P} so as to prevent displacement of the piston 272, and thereby releasably retain the stem 12, when the input device 16 is stationary or non-operational. However, when the input device 16 is rotated, the valve actuator 274 displaces a flow control element (not depicted) of the control valve 276 to an open position to enable fluid to flow freely into and out of the chamber C_{P} in response to movement of the stem 12, and thus the piston 272, so as to permit unhindered operation of the valve operator assembly 10. Most preferably, the piston 272 and the housing 274 are provided by a conventional hydraulic cylinder 280. However, the hydraulic assembly 270 may be constructed in any other appropriate manner and the scope of the present invention encompasses all appropriate structures of the hydraulic assembly 270 and the lock mechanism 11 in general.

It will be appreciated by those skilled in the art that changes could be made to the embodiments described above without departing from the broad inventive concept thereof. It is understood, therefore, that this invention is not limited to the particular embodiments disclosed, but it is intended to cover modifications within the spirit and scope of the present invention as generally defined in the appended claims.

We claim:

1. A high efficiency operator assembly for a valve for controlling flow through a passage, the valve including a closure element movable between a closed position at which the member substantially obstructs the passage and an open position, the operator assembly comprising:
a movable stem having opposing first and second ends, the first end being connectable with the closure element such that displacement of the stem moves the closure element between the open and closed positions;
a stem driver rotatable about a central axis, engaged with the stem, and configured to displace the stem when the driver angularly displaces about the central axis;
an input device rotatable about a central axis; and
a lock mechanism operatively engageable with one of the stem, the stem driver, and the input device so as to retain the closure element at about particular position when the input device remains generally at a particular angular position about the input axis.

2. The valve operator assembly as recited in claim 1 wherein the lock device includes one of:
a clutch configured to operatively couple the input device with the stem driver such that rotation of the input device rotates the stem driver about the driver axis and configured to substantially prevent angular displacement of the stem driver when the stem applies torque to the driver while the input device remains generally at a particular angular position about the input axis;
a brake including a fixed member and a brake member configured to releasably couple the one of the stem, the stem driver and the input device with the fixed member when the input device remains generally a particular angular position about the input axis; and
a hydraulic assembly configured to exert fluid pressure on one of the stem, the stem driver and the input device so as to releasably retain the one of the stem, the stem driver and the input device when the input device remains generally at a particular angular position about the input axis.

3. The valve operator assembly as recited in claim 1 wherein the lock mechanism is configured to substantially prevent displacement of the stem when fluid pressure is applied to the closure element.

4. The valve operator assembly as recited in claim 1 wherein the stem is linearly displaceable along a stem axis and the lock mechanism is configured to releasably retain the stem at about a fixed position along the stem axis when the input device remains generally at a particular angular position about the input axis.

5. The valve operator assembly as recited in claim 2 wherein the clutch is configured such that rotation of the input device in a first angular direction rotates the stem driver in the first angular direction so as to linearly displace the stem in a first direction along the stem axis and rotation of the input device in a second, opposing angular direction rotates the stem driver in the second direction so as to linearly displace the stem in a second, opposing direction along the stem axis.

6. The valve operator assembly as recited in claim 2 wherein the clutch includes:
an input member rotatable about the axis and having inner and outer axial ends;
a clutch member fixed with respect to the axis; and
an output member with inner and outer axial ends and being slidably coupled with the stem driver such that the output member is displaceable along the axis relative to the stem driver and angular displacement of the output member angularly displaces the stem driver, the output member being releasably engageable with the clutch member so as to substantially prevent angular displacement of the output member and having at least one drive surface proximal to the inner end and extending circumferentially and axially with respect to the central axis, the input member inner end being operatively engageable with the output member drive surface such that angular displacement of the input member axially displaces the output member out of engagement with the clutch member and then angularly displaces the output member about the central axis to rotate the stem driver.

7. The valve operator assembly as recited in claim 6 further comprising a biasing member configured to bias the output member toward the input member such that the output member engages with the clutch member.

8. The valve operator assembly as recited in claim 6 wherein the clutch member has an inner circumferential surface tapering axially so as to be generally conical surface and the output member has an outer circumferential surface tapering axially so as to be generally conical, the output member being at least partially disposable within the clutch member such that the output member outer surface engages with the clutch member inner surface.

9. The valve operator assembly as recited in claim 6 wherein the clutch further includes at least one generally spherical transfer member disposed between the input and output members and configured such that angular displacement of the input member pushes the transfer member against the output member drive surface such that the transfer member displaces a distance along the drive surface until the retention surface disengages from the friction surface, and then the input member pushes the output member to angularly displace about the central axis through the transfer member.

10. The valve operator assembly as recited in claim 9 wherein the output member includes a plurality of drive surfaces spaced circumferentially about the central axis, and the at least one transfer member includes a plurality of the transfer members each disposed against a separate one of the drive surfaces.

11. The valve operator assembly as recited in claim 9 wherein:
the output member has a generally cylindrical body with opposing, first and second ends spaced apart along the axis, the first end being at least generally adjacent to the input member;
the drive surface has two opposing ends located at the body first end and a central section spaced axially from the body first end; and
the output member displaces axially when the input member forces the transfer member to displace generally from the drive surface central portion and towards one of the drive surface ends.

12. The valve operator assembly as recited in claim 11 wherein:
the output member has a radial end surface at the first end and at least one elongated cavity extending axially from the end surface and partially circumferentially about the central axis, the cavity being at least partially defined by the at least one drive surface; and
the input member includes a radial end surface, the end surface generally facing and spaced axially from the output member end surface, and at least one cavity extending axially from the end surface and partially circumferentially about the central axis and generally aligned with the output member cavity, the at least one transfer member being partially disposed within each of the aligned input and output member cavities.

13. The valve operator assembly as recited in claim 2 wherein the clutch has a central axis substantially collinear with the input and driver axes and includes:
an input member connected with the input device and rotatable about the clutch axis;
an output member connected with the stem driver and rotatable about the clutch axis; and
a coupler configured to operatively couple the input member with the output member such that the input member rotatably drives the output member to rotate about the clutch axis so at angularly displace the stem driver about the driver axis when the input device angularly displaces about the input axis and configured to substantially prevent angular displacement of the input member when the output member angularly displaces relative to the input member.

14. The valve operator assembly as recited in claim 13 wherein:
the clutch further includes a housing having an inner circumferential surface defining a bore, the input and output members and the coupler each being disposed at least partially with the housing bore; and
the clutch coupler includes a movable brake member configured to releasably frictionally engage with the housing inner surface when the output member angularly displaces relative to the input member so as to retain the input and output members generally at a particular angular position about the clutch axis.

15. The valve operator assembly as recited in claim 14 wherein:
the input member has a radial end surface and a slotted opening extending generally axially from the end surface and generally radially through the input member, the at least one brake member being disposed within the input member recess;
the output member has a radial end surface spaced axially from the input member end surface and at least one cavity extending generally axially from the end surface; and
the clutch coupler further includes at least one pin having a first end engageable with the brake member and a second end disposed within the output member cavity such that rotation of the input member rotatably drives the output member through the brake member and the pin and such that angular displacement of the output member relative to the input member pivots the pin within the output member cavity so that the pin pushes the brake member to displace at least generally radially within the input member recess and into frictional engagement with the housing inner surface so as to releasably retain the input and output members at about a particular angular position.

16. The valve operator assembly as recited in claim 15 wherein the coupler includes two brakes and two pins, each brake having a pair of notches and the two brakes being arranged such that each notch is aligned with a separate notch of the other brake to define one of a pair of openings, the first end of each pin being disposed within a separate one of the pair of openings, the coupler being configured such that angular displacement of the input member rotates the two brakes so that the two pins push the stem driver to rotate about the stem driver axis and such that angular displacement of the output member relative to the input member pivots each of the two pins within the output member cavities such that each pin pushes one of the brakes to pivot into frictional engagement with the housing inner surface.

17. The valve operator assembly as recited in claim 1 wherein:
the stem includes an elongated cylindrical bar having an outer circumferential surface and at least one exterior thread formed in the outer surface; and
the stem driver includes a generally cylindrical body with an inner circumferential surface defining a central bore, the body being disposed coaxially about a portion of the stem bar such that the bar extends through the bore, the driver body having at least one interior thread formed in the inner surface and operatively coupled with the stem exterior thread such that rotation of the stem driver simultaneously angular displaces the stem bar about the stem axis and linearly displaces the bar along the stem axis.

18. The valve operator assembly as recited in claim 17 wherein the stem driver further includes one of:
a plurality of balls disposed between the stem driver inner thread and the stem outer thread such that rotation of the stem driver causes each ball to roll simultaneously within an inner helical groove defined between adjacent sections of the stem driver inner thread and within a outer helical groove defined between adjacent sections of the stem outer thread; and
a plurality of threaded rods spaced circumferentially about the driver axis, each rod having a central axis and an exterior thread simultaneously engaged with the driver interior thread and with the stem exterior thread such that rotation of the stem driver rotates each rod about each rod central axis.

19. The valve operator assembly as recited in claim 17 wherein the stem driver further includes an elongated tubular connector having a first end connected with the input device, a second end connected with the cylindrical body, and a central bore extending generally between the first and second ends, at least a portion of the stem being displaceable within the bore when the stem displaces along the stem axis.

20. The valve operator assembly as recited in claim 1 wherein the input device includes a handle connected with and configured to manually rotate the clutch so as to angularly displace the stem driver.

21. The valve operator assembly as recited in claim 1 wherein the valve further includes a housing having an operator passage extending generally perpendicularly to the flow passage and the valve operator assembly further includes an operator housing having opposing first and second ends and an interior chamber, the clutch, stem driver and at least a portion of the stem being disposed within the chamber, the drive device being connected with the operator housing first end and the operator housing second end being connectable with the valve housing such that a portion of the stem extends into the operator passage.

22. The valve operator assembly as recited in claim 21 further comprising at least one bearing configured to rotatably support the stem driver within the operator housing.

23. A high efficiency valve assembly for controlling flow through a passage, the valve assembly comprising:
a closure element movable between a closed position at which the member substantially obstructs the passage and an open position;
a movable stem connected with the closure element and configured to displace the closure element between the open and closed positions;
a stem driver rotatable about a central axis, engaged with the stem, and configured to move the stem when the driver angularly displaces about the central axis;
a rotatable input device; and
a clutch configured to operatively couple the input device with the stem driver such that rotation of the input device rotates the stem driver about the driver axis and configured to substantially prevent angular displacement of the stem driver from torque applied by the stem.

24. The valve assembly as recited in claim 23 wherein the closure element includes a gate member having a through hole and at least one generally solid section, the gate member through hole being alignable with the flow passage when the closure element is disposed in the open position and the gate member generally solid section extending across and substantially obstructing the passage when the closure element is disposed in the closed position.

25. The valve assembly as recited in claim 23 wherein:
a valve housing having an interior surface providing the valve seat and at least partially defining the flow passage and an operator passage extending generally perpendicularly to the flow passage, the closure element being movable through the operator passage when moving between the open and closed positions; and
an operator housing having opposing ends and an interior chamber, the clutch, stem driver and at least a portion of the stem being disposed within the chamber, the drive device being connected with the operator housing upper end and the operator housing lower end being connected with the valve housing.

26. A high efficiency operator assembly for a valve for controlling flow through a passage, the valve including a closure element movable between a closed position at which the member substantially obstructs the passage and an open position, the operator assembly comprising:
a movable stem connectable with the closure element and configured to displace the closure element between the open and closed positions when the stem linearly displaces between first and second position;
a stem driver rotatable about a central axis, engaged with the stem, and configured to displace the stem when the driver angularly displaces about the central axis;
an input device rotatable about a central axis; and
a formsprag clutch configured to operatively couple the input device with the stem driver such that rotation of the input device rotates the stem driver about the driver axis and configured to substantially prevent angular displacement of the stem driver when the stem applies torque to the driver while the input device remains generally at a particular angular position about the input axis.

27. The valve operator assembly as recited in claim 26 wherein:
the stem includes an elongated cylindrical bar having an outer circumferential surface and at least one exterior thread formed in the outer surface; and
the stem driver includes a generally cylindrical body with an inner circumferential surface defining a central bore, the body being disposed coaxially about a portion of the stem bar such that the bar extends through the bore, the driver body having at least one interior thread formed in the inner surface and operatively coupled with the stem exterior thread such that rotation of the stem driver simultaneously angular displaces the stem bar about the stem axis and linearly displaces the bar along the stem axis, and one of:
a plurality of balls disposed between the stem driver inner thread and the stem outer thread such that rotation of the stem driver causes each ball to roll simultaneously within an inner helical groove defined between adjacent sections of the stem driver inner thread and within a outer helical groove defined between adjacent sections of the stem outer thread; and
a plurality of threaded rods spaced circumferentially about the driver axis, each rod having a central axis and an exterior thread simultaneously engaged with the driver interior thread and with the stem exterior thread such that rotation of the stem driver rotates each rod about each rod central axis.

28. A high efficiency operator assembly for a valve for controlling flow through a passage, the valve including a closure element movable between a closed position at which the member substantially obstructs the passage and an open position, the operator assembly comprising:
a movable stem connectable with the closure element and configured to displace the closure element between the open and closed positions;
a stem driver rotatable about a central axis, engaged with the stem, and configured to displace the stem when the driver angularly displaces about the central axis;
an input device rotatable about a central axis; and
a clutch configured to operatively couple the input device with the stem driver such that rotation of the input device rotates the stem driver about the driver axis and configured to substantially prevent angular displacement of the stem driver when the stem applies torque to the driver while the input device remains generally at a particular angular position about the input axis.
